(19) United States
(12) Patent Application Publication
(10) Pub. No.: US 2019/0384100 A1
(43) Pub. Date: Dec. 19, 2019

(54) LIQUID CRYSTAL PANEL AND LIQUID CRYSTAL DISPLAY DEVICE

(71) Applicant: Wuhan China Star Optoelectronics Technology Co., Ltd., Wuhan, Hubei (CN)

(72) Inventors: Hualun YU, Wuhan, Hubei (CN); Wenshuai GUO, Wuhan, Hubei (CN); Anshi LI, Wuhan, Hubei (CN)

(21) Appl. No.: 15/579,183

(22) PCT Filed: Nov. 23, 2017
(86) PCT No.: PCT/CN2017/112698

§ 371 Date: Dec. 1, 2017

(30) Foreign Application Priority Data
Oct. 31, 2017 (CN) 201711047588.6

(51) Int. Cl. G02F 1/1335

(52) U.S. Cl. CPC G02F 1/133514; G02F 1/133512

(57) ABSTRACT

The disclosure discloses a liquid crystal panel, comprising an array substrate and a color filter substrate arranged opposite to a cell, the color filter substrate comprising a black matrix, the black matrix comprising a first portion in a display area and a second portion in a non-display area, wherein a second portion of the black matrix is provided with a groove surrounding the display area, the groove penetrates the second portion of the black matrix in a thickness direction of the second portion of the black matrix, a light resistance layer of two colors is arranged in the second portion of the black matrix to close an opening of the groove, and the resistance material layers of two colors are selected from any two of a red light resistance layer, a green resistance material layer and a blue color resistance material layer

### RELATED APPLICATIONS

The present application is a National Phase of International Application Number PCT/CN2017/112698, filed Nov. 23, 2017, and claims the priority of China Application No. 201711047588.6, filed Oct. 31, 2017.

### FIELD OF THE DISCLOSURE

The disclosure relates to a display technical field, and more particularly to a. liquid crystal panel and a liquid crystal display device.

### BACKGROUND

A liquid crystal display (LCD) is a flat and thin display device. The liquid crystal display includes a certain number of color or black and white pixels placed in front of a light source or a reflecting surface. The LCD has characteristics of very low power consumption, high quality, small size and light weight. Thus it is very popular with the public and become a mainstream of the display. A common liquid crystal panel includes at least a TFT array substrate and a color filter substrate arranged opposite to each other, and a liquid crystal layer between the array substrate and the color filter substrate. The array substrate and the color filter substrate are also respectively stackedly connected to a lower polarizer and an upper polarizer.

As shown in FIG. 1, the color filter substrate generally includes a base substrate 1 and a black matrix (BM) 2 and light resistance R, G and B arranged on the base substrate 1. Each light resistance R, G and B corresponds to one sub-pixel. The black matrix 2 is spaced by any two adjacent sub-pixels to prevent light leakage. Generally, a material of the black matrix 2 is an insulating material, but still has certain conductivity, so that during a manufacturing and application process, a static electricity may enter and be distributed, along the black matrix 2 from an edge of the base substrate 1, in the color filter substrate, so as to result in abnormal pictures.

In order to solve the above technical problem, as shown in FIG. 1, a groove 3 is generally provided in a position of the black matrix 2 in a non-display area, and the groove 3 blocks a transmission of the static electricity toward a display area in the color filter substrate. However, since the black matrix 2 is used to shield the light from light leakage, a position corresponding to the groove 3 may not shield the light after the groove 3 is provided, thereby resulting in a risk of light leakage at the edge of the LCD.

### SUMMARY

In view of the shortcomings of the prior art, the disclosure provides a liquid crystal panel, The liquid crystal panel avoids light leakage at the edge of the liquid crystal panel while preventing transmission of the static electricity along the black matrix toward the display area in the color filter substrate.

In order to achieve the above object, the disclosure adopts the following technical solutions,

There is provided a liquid crystal panel, including an array substrate and a color filter substrate arranged opposite to a cell, the color filter substrate including a black matrix, the black matrix including a first portion in a display area and a second portion in a non-display area, wherein a second portion of the black matrix is provided with a groove surrounding the display area, the groove penetrates the second portion of the black matrix in a thickness direction of the second portion of the black matrix, a light resistance layer of two colors is arranged in the second portion of the black matrix to close an opening of the groove, and the resistance material layers of two colors are selected from any two of a red light resistance layer, a green resistance material layer and a blue color resistance material layer.

Further, the resistance material layers of two colors are selected as the red light resistance layer and the blue color resistance material layer.

Further, the blue light resistance layer and the red light resistance layer are sequentially stackedly arranged on the second portion of the black matrix.

Further, a thickness of the blue light resistance layer is 1.4 μm and a thickness of the red light resistance layer is 1.5 μm.

Further, the red light resistance layer and the blue light resistance layer are sequentially stackedly arranged on the second portion of the black matrix.

Further, a thickness of the blue light resistance layer is 0.8 μm and a thickness of the red light resistance layer is 2.1 μm.

Further, the color filter substrate further includes a light resistance layer, the light resistance layer includes a red light resistance layer, a green light resistance layer and a blue light resistance layer, and the first portion of the black matrix is provided with an array of openings, and each of the red light resistance layer, the green light resistance layer and the blue light resistance layer is correspondingly arranged in one of the openings.

The disclosure also provides a liquid crystal display device, including a liquid crystal panel and a backlight module, the liquid crystal panel being arranged opposite to the backlight module, the backlight module providing a display light source to the liquid crystal panel, so that the liquid crystal panel displays an image, wherein the liquid crystal panel is the above liquid crystal panel.

The advantageous effects of the disclosure are: according to the disclosure, a groove is provided in a position on the black matrix of the color filter substrate in a non-display area. The groove prevents the static electricity from being transmitted along the black matrix toward a display area in the color filter substrate. Meanwhile, a light resistance material layer of two colors completely covering the grooves is arranged in a position on the black matrix in the non-display area, so as to prevent the light emitted from the backlight module from penetrating the black matrix through the grooves, thereby avoiding the light leakage at the edge of the liquid crystal panel.

### BRIEF DESCRIPTION OF THE FIGURES

The above and other aspects, features and advantages of the embodiments of the disclosure will become more apparent from the following description taken in conjunction with the accompanying figures, in which:

FIG. 1 is a schematic structural view of a conventional color filter substrate;

FIG. 2 is a schematic structural view of a liquid crystal panel according to an embodiment of the disclosure;

FIG. 3 is a schematic structural view of a black matrix according to an embodiment of the disclosure;

FIG. 4 is a schematic structural view of a liquid crystal display device provided by an embodiment of the disclosure.

### DETAILED DESCRIPTION OF PREFERRED EMBODIMENTS

To make the objectives, technical solutions, and advantages of the disclosure clearer, the following describes the specific implementation manners of the disclosure in detail with reference to the accompanying figures. Examples of these preferred embodiments are illustrated in the figures. The embodiments of the disclosure shown in the figures and described in the figures are merely exemplary and the disclosure is not limited to these embodiments.

Here, it should also be illustrated that in order to avoid obscuring the disclosure by unnecessary details, only structures and/or processing steps closely related to the solutions according to the disclosure are shown in the figures. Other details having little relation with the disclosure are omitted.

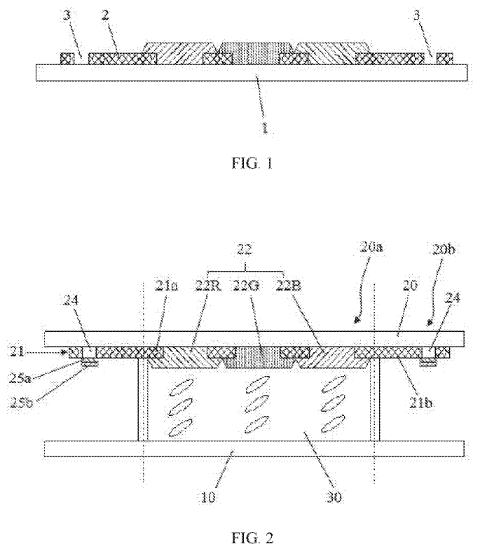

Firstly, in this embodiment, a liquid crystal panel is provided. As shown in FIG. 2, the liquid crystal panel includes an array substrate 10 and a color filter substrate 20 arranged to be opposite to each other. A liquid crystal layer 30 is arranged between the array substrate 10 and the color filter substrate 20. Wherein a circuit structure for driving pixel display is arranged in the array substrate 10, such as a thin film transistor, a data line, a scan line and a pixel electrode and the like. The color filter substrate 20 includes a display area 20a and a non-display area 20b surrounding the display area 20a. A black matrix 21 and a light resistance layer 22 are arranged on the color filter substrate 20.

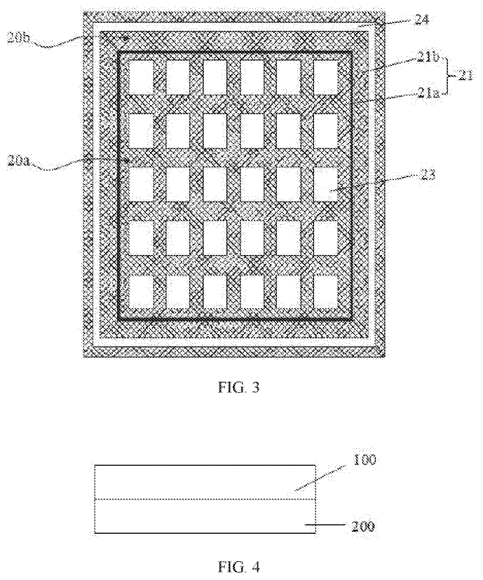

Refer to FIGS. 2 and 3, the black matrix 21 includes a first portion 21a located in the display area 20a and a second portion 21b located in the non-display area 20b. The light resistance layer 22 is arranged in the display area 20a, The light resistance layer 22 includes a red light resistance layer 22R, a green light resistance layer 22G and a blue light resistance layer 22B. The first portion 21a of the black matrix 21 is provided with an array of openings 23, and each of the red light resistance layer 22R, the green light resistance layer 22G and the blue light resistance layer 22B is correspondingly arranged in the openings. It should be noted that FIG. 2 only shows by way of example one red light resistance layer 22R, one green light resistance layer 22G and one blue light resistance layer 22B. Generally, in the liquid crystal panel, one red light resistance layer 22R corresponds to one red sub-pixel, one green light resistance layer 22G corresponds to one green sub-pixel, one blue light resistance layer 22B corresponds to one blue sub-pixel, and each pixel unit includes one red sub-pixel, one green sub-pixel and one blue sub-pixel. FIG, 3 only shows by way of example a few openings 23.

Refer to FIGS. 2 and 3 continuously, the second portion 21b of the black matrix 21 is provided with a groove 24 surrounding the display area 20a. The groove 24 penetrates the black matrix 21 in the thickness direction of the black matrix 21. That is, the groove 24 divides the second portion 21b into two portions completely disconnected with each other in the edge region of the black matrix 21. Thus, the groove 24 may prevent the static electricity from transmitting along the black matrix 21 toward the display area 20a in the color filter substrate 20, so as to prevent the static electricity from adversely affecting the display pictures of the liquid crystal panel.

Further, in this embodiment, as shown in FIG. 2, on the second portion 21b of the black matrix 21, color resistance material layers 25a and 25b of two colors are sequentially stackedly arranged above the openings corresponding to the grooves 2425a25b, and color resistance material layers 25a and 25b of two colors are selected from any two of the red light resistance layer, the green light resistance material layer, and the blue light resistance material layer. By providing color resistance material lavers 25a and 25b of two colors, it is equivalent to adding a filter layer in front of the groove 24. Generally, after a white light emitted by the backlight module goes through sequentially color resistance material layers 25a and 25b of two colors, the light is completely filtered, thus no light leakage occurs in the position of the groove 24. In this embodiment, by providing color resistance material layers 25a and 25b of two colors, it may better ensure that no light leakage occurs in the position of the groove 24.

In a preferred solution, the color resistance material layers 25a and 25b of two colors are selected as a red color resistance material layer and a blue color resistance material layer.

Further, the color resistance material layer 25a is a red color resistance material layer, and the color resistance material layer 25b is a blue color resistance material layer. The red color resistance material layer and the blue color resistance material layer are sequentially stackedly arranged on the second portion 21b of the black matrix 21 to close the groove 24, In this case, a thickness of the blue color resistance material layer is 0.8 μm, and a thickness of the red color resistance material layer is 2.1 μm.

Alternatively, as another embodiment of the disclosure, the color resistance material layer 25a is a blue color resistance material layer, and the color resistance material layer 25b is a red color resistance material layer. The red color resistance material layer and the blue color resistance material layer are sequentially stackedly arranged on the second portion 21b of the black matrix 21 to close the groove 24. In this case, a thickness of the blue color resistance material layer is 1.4 pm, and a thickness of the red color resistance material layer is 1.5 μm. This is because a translucency of the red color resistance material layer is better and a translucency of the blue color resistance material layer is poorer. Thus the blue color resistance material layer is formed closer to a side located by the black matrix 21, and this may increase the thickness of the blue color resistance material layer, and reduce the thickness of the red color resistance material layer. Under the condition of maintaining the overall film thickness, the optical opacity may be further improved, so that the light leakage phenomenon may be more effectively improved.

In the embodiment, the disclosure further provides a display device, including a liquid crystal panel 100 and a backlight module 200, the liquid crystal panel 100 being arranged opposite to the backlight module 200, the backlight module 200 providing a display light source to the liquid crystal panel 100 so that the liquid crystal panel 100 displays an image. Wherein the liquid crystal panel 100 adopts the liquid crystal panel provides by the embodiment.

In summary, in the liquid crystal panel according to the embodiment of the disclosure, a groove is provided in a position on the black matrix of the color filter substrate in a non-display area. The groove prevents the static electricity from being transmitted along the black matrix toward a display area in the color filter substrate. Meanwhile, a light resistance material layer of two colors completely covering the grooves is arranged in a. position on the black matrix in the non-display area, so as to prevent the light emitted from the backlight module from penetrating the black matrix through the grooves, thereby avoiding the light leakage at the edge of the liquid crystal panel.

It should be noted that, in this document, relational terms such as first and second and the like are merely used to distinguish one entity or operation from another entity or operation, and do not necessarily require or imply that there is any such actual relationship or order between the entity and the operation. Moreover, the terms “including”, “comprising” or any other variations thereof are intended to cover a non-exclusive inclusion such that a process, method, article, or apparatus including a list of elements include not only those elements but also other elements not clearly illustrated, or elements inherent to such process, method, article, or apparatus. Under the condition of no further limitations, an element limited by the statement “including one . . . ” does not exclude the existence of additional identical elements in the process, method, article, or apparatus including the element.

The above descriptions are merely specific embodiments of the present application. It should be noted that those skilled in the art may make some improvements and modifications without departing from the principle of the present application. These improvements and modifications should also be regarded as e protection scope of this application.

What is claimed is:

1. A liquid crystal panel, comprising an array substrate and a color filter substrate arranged opposite to a cell, the color filter substrate comprising a black matrix, the black matrix comprising a first portion in a display area and a second portion in a non-display area, wherein a second portion of the black matrix is provided with a groove surrounding the display area, the groove penetrates the second portion of the black matrix in a thickness direction of the second portion of the black matrix, a light resistance layer of two colors is arranged in the second portion of the black matrix to close an opening of the groove, and the resistance material layers of two colors are selected from any two of a red light resistance layer, a green resistance material layer and a blue color resistance material layer.

2. The liquid crystal panel according to claim 1, wherein the resistance material layers of two colors is selected as the red light resistance layer and the blue color resistance material layer.

3. The liquid crystal panel according to claim 2, wherein the blue light resistance layer and the red light resistance layer are sequentially stackedly arranged on the second portion of the black matrix.

4. The liquid crystal panel according to claim 3, wherein a thickness of the blue light resistance layer is 1.4 μm and a thickness of the red light resistance layer is 1.5 μm.

5. The liquid crystal panel according to claim 2, wherein the red light resistance layer and the blue light resistance layer are sequentially stackedly arranged on the second portion of the black matrix.

6. The liquid crystal panel according to claim 5, wherein a thickness of the blue light resistance layer is 0.8 μm and a thickness of the red light resistance layer is 2.1 μm.

7. The liquid crystal panel according to claim 1, wherein the color filter substrate further comprises a light resistance layer, the light resistance layer comprises a red light resistance layer, a green light resistance layer and a blue light resistance layer, and the first portion of the black matrix is provided with an array of openings, and each of the red light resistance layer, the green light resistance layer and the blue light resistance layer is correspondingly arranged in one of the openings.

8. The liquid crystal panel according to claim 2, wherein the color filter substrate further comprises a light resistance layer, the light resistance layer comprises a red light resistance layer, a green light resistance layer and a blue light resistance layer, and the first portion of the black matrix is provided with an array of openings, and each of the red light resistance layer, the green light resistance layer and the blue light resistance layer is correspondingly arranged in one of the openings.

9. The liquid crystal panel according to claim 3, wherein the color filter substrate further comprises a light resistance layer, the light resistance layer comprises a red light resistance layer, a green light resistance layer and a blue light resistance layer, and the first portion of the black matrix is provided with an array of openings, and each of the red light resistance layer, the green light resistance layer and the blue light resistance layer is correspondingly arranged in one of the openings.

10. The liquid crystal panel according to claim 4, wherein the color filter substrate further comprises a light resistance layer, the light resistance layer comprises a red light resistance layer, a green light resistance layer and a blue light resistance layer, and the first portion of the black matrix is provided with an array of openings, and each of the red light resistance layer, the green light resistance layer and the blue light resistance layer is correspondingly arranged in one of the openings.

11. The liquid crystal panel according to claim 5, wherein the color filter substrate further comprises a light resistance layer, the light resistance layer comprises a red light resistance layer, a green light resistance layer and a blue light resistance layer, and the first portion of the black matrix is provided with an array of openings, and each of the red light resistance layer, the green light resistance layer and the blue light resistance layer is correspondingly arranged in one of the openings.

12. The liquid crystal panel according to claim 6, wherein the color filter substrate further comprises a light resistance layer, the light resistance layer comprises a red light resistance layer, a green light resistance layer and a blue light resistance layer, and the first portion of the black matrix is provided with an array of openings, and each of the red light resistance layer, the green light resistance layer and the blue light resistance layer is correspondingly arranged in the openings.

13. A liquid crystal display device, comprising a liquid crystal panel and a backlight module, the liquid crystal panel being arranged opposite to the backlight module, the backlight module providing a display light source to the liquid crystal panel , so that the liquid crystal panel displays an image, wherein the liquid crystal panel is the liquid crystal panel according to claim 1.
